(19) United States
(12) Patent Application Publication
(10) Pub. No.: US 2008/0203145 A1
(43) Pub. Date: Aug. 28, 2008

(54) OPERATING SYSTEM FOR MANAGING PUBLIC PARKING LOT

(76) Inventor: Domingos Nelson Martins, Sao Paulo (BR)

Correspondence Address: LUCAS & MERCANTI, LLP, 475 PARK AVENUE SOUTH, 15TH FLOOR, NEW YORK, NY, 10016, US

(21) Appl. No.: 11/539,437

(22) Filed: Oct. 6, 2006

(30) Foreign Application Priority Data
Aug. 29, 2006 (BR) PI-0603648-1

(51) Int. Cl. G06F 17/00

(52) U.S. Cl. 235/375

(57) ABSTRACT

Operating system for managing public parking lot which provides a solution for controlling public parking lots, by using for telecommunications technology which, in combination with mobile devices, allows interconnection of sales terminals with a supervisory program in order to make the process electronic and automated. A reception module receives information about the vehicle, an electronic coupon issuing module generates the electronic coupon based on the provided information and payment, which data is stored in together, and an activation and deactivation module enables activation and deactivation of each electronic coupon upon entry of the number of the electronic coupon and the password of that electronic coupon. The activation and deactivation module provides a confirmation of activation or deactivation of the electronic coupon to a telephone number associated with the electronic coupon.

### FIELD OF INVENTION

The present invention relates generally to an operating system and method for managing a parking lot and more specifically to an operating system and method for managing a public parking lot.

### BACKGROUND OF THE INVENTION

Management of public parking lots is currently carried out through use of tokens, which are purchased by the users and placed inside the cars in a location visible to a parking lot attendant or monitoring agent so that the agent can verify, by viewing the token, if payment has been made to permit the presence of the parked vehicle in the parking lot.

This technique which requires a parking lot attendant to view all vehicles in the parking lot is often imprecise, not highly productive, and moreover allows for a substantial degree of errors and/or frauds.

### OBJECTS AND SUMMARY OF INVENTION

It is an object of the present invention to provide a new and improved operating system and method for managing parking lots and specifically public parking lots.

It is another object of the present invention to provide a new and improved parking lot management system which overcomes drawbacks and inconveniences of existing parking lot management systems, including the one described above.

In order to achieve these objects and others, an operating system for managing public parking lots in accordance with the invention generally uses telecommunications technology and mobile devices to allow interconnection of sales terminals (at which payment for permission to park vehicles in the parking lot is received) with a supervisory entity and thereby makes the entire parking lot management process electronic and automated.

In one embodiment of the invention, the operating system for managing public parking lots is based on obtaining an electronic credit which can be purchased at authorized points of sale, previously activated in the system, or by any remote data transmitting means, such as, for example, through the Internet or through a mobile phone. Electronic credits may be pre-paid or post-paid.

During the electronic credit purchase phase, an electronic coupon will be issued by means of, for example, an electronic terminal incorporated into the system. The electronic coupon will include an identification of the vehicle or its owner, an amount of credited hours, a password and a telephone number for activating and deactivating use, as well as the number of the coupon. The telephone number may the number of a mobile telephone or similar telecommunications device. Such an electronic terminal informs a system server about the transaction resulting in issuance of the electronic coupon. The vehicle, after being activated by the system, i.e., identified in an issued electronic coupon, is in a regular, permitted condition in the parking lot and can remain parked during a time period determined by a local parking lot management or municipal body. Alternatively, in the absence of a specific determination of the maximum permitted time, the vehicle can remain parked in the parking lot for the time period determined upon activation of the system, e.g., upon issuance of the electronic coupon.

It is envisioned that supervision of the parking lot will be carried out by an agent duly qualified for this purpose, with the aid of PDA (Personal Digital Assistant) type device, using a specific software for such application. The PDA is activated together with the mobile telephone operator so that it becomes possible to transmit data and connect to the Internet. In this manner, the agent can access the system in order to obtain information about the status of parked vehicles and information about the vehicle's characteristics, so as to avoid frauds. In the event the information in the system does not correspond to the facts as determined by the agent, e.g., the vehicle's characteristics are different, then a determination is made that the condition of the parked vehicle is irregular and the system can notify appropriate entities about such irregularity. Furthermore, all supervising operations are stored in the system for auditing purposes.

In one embodiment of the invention, the operating system enables a user to purchase an electronic credit from a network of authorized points of sale or by remotely and directly accessing the operating system which results in the issuance of an electronic coupon. The electronic coupon contains the amount of hours desired for parking a vehicle in the parking lot, and an identification or specification of one or more which can be parked in the parking for those hours (to allow a fleet of vehicles to use the paid-for parking hours). After confirmation of payment for purchasing such coupon, the activation and deactivation of use of the parking conditions will be remotely carried out. These parking conditions will also be remotely informed to a supervising agent so that the agent can monitor the parked vehicles in his monitoring area, and when a vehicle is impermissibly parked in the parking lot, notify someone of the violation.

### BRIEF DESCRIPTION OF THE DRAWING

For a better understanding of the operating system of managing parking lots in accordance with the invention, reference is made to the annexed drawing, wherein:

FIG. 1 shows a block diagram of one embodiment of an operating system for managing public parking lot in accordance with the invention.

### DETAILED DESCRIPTION FO THE INVENTION

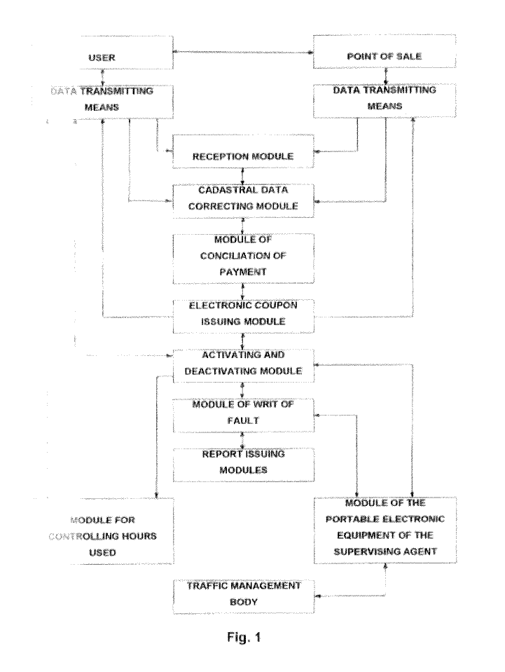

With reference to FIG. 1, an operating system for managing parking lots in accordance with the invention is based generally on use of telecommunication technology and mobile devices, and incorporates a network of point of sale locations or terminals and/or allows for remote access through any data transmitting device (data transmitting means in FIG. 1) to enable the purchase of electronic credit from an authorized point of sale. For example, there can be a sales terminal duly installed and connected or set-up in the system which enables purchase of the electronic credits. One such sales terminal is a POS (point of sale) type device (see FIG. 1). Conciliation or confirmation of payment of the electronic credit is required to enable issuance of an electronic coupon by the POS-type device.

Instead of a POS-type device, electronic credits can be purchased by a user through remote access to the system, for example, via the Internet or through fixed or mobile telephony system, using appropriate data transmitting means (see FIG. 1). Confirmation or conciliation of payment made through the remote access is required to enable issuance of an electronic coupon.

Electronic coupons can be pre-paid or post-paid. Independent on the manner in which the electronic credit is purchased to enable issuance of an electronic coupon, the system will request information about the vehicle(s) to be parked in the parking lot. This information may include the identification of the vehicle, for example, the number plate or number of the license plate, or identification of the owner of a fleet of vehicles, for example, the fleet registration number, the amount of hours he wants to purchase, a telephone number which will be used for activating and deactivating the use of the electronic credit (preferably a mobile telephone number).

The information is received at a Receiving Module of the system. The system also includes a Cadastral Data correcting module which enables the user to alter the information supplied by the user when purchasing the electronic credit, for example, the number plate of the vehicle and/or the mobile telephone number. This allows the user to correct data entry errors. Upon confirmation of the input information, a Conciliation of Payment Module conciliates or confirms payment and the payment of a requested electronic coupon is generated, by the Electronic Coupon Issuing Module.

The electronic coupon may take the form of a numbered receipt which contains the information supplied by the user to the system as well as an optional password to be used for activating and deactivating the credit of parking hours paid for by the used. This activation or deactivation of the purchased allotment of parking hours, or parking privileges, can be carried out by sending a SMS (Short Message System) type message, through the mobile telephone whose number was provided to the system, and/or by means of a Call Center or an Assistance Center of the system. The user provides the number and the password of the receipt of the electronic coupon, and regardless of the manner in which the activation or deactivation of the parking hours is being carried out, the request is received in an Activating and Deactivating Module which will return a confirmation of the operation to the mobile telephone whose number was provided to the system in association with the electronic coupon, i.e., when activating the electronic coupon.

If the parking period for an electronic coupon is near its end, the system may be designed to send, through a Module for Controlling Hours Used, a message to the mobile telephone registered in the system in association with the issuance about the electronic coupon, so that the user can, if he still has credit and/or if it is permitted by the local rules for public parking lots, extend the activating period of his electronic coupon. When an extension is not possible, the system would simply inform the user about the need to leave the parking lot.

Checking of the use of the system will be carried out by an agent duly qualified with the system for such activity. The agent is provided with a portable electronic device, such as for example, a PDA (Personal Digital Assistant), duly activated with the mobile telephony operator, and using a property software specific for this application, with access to data transmission and connection to the Internet. Through use of the PDA, the supervising agent can consult the system in order to obtain, by typing the number plate of the vehicle parked in his inspecting or monitoring area, information on its situation. The agent's request is received at the Activating and Deactivating Module, which after considering the number plate supplied, will also consult the Electronic Coupon Issuing Module (see FIG. 1), returning the information to the Module of the Portable Electronic Equipment of the Supervising Agent.

The returned information may be an indication that of confirmation that the vehicle is exempt of this service, i.e., is not required to pay for parking in the parking lot; or that the vehicle is in a regular, permitted condition with its electronic coupon activated, and in this case it may optionally also be informed the remaining minutes; or that the vehicle is in an irregular condition with the activation period of its electronic coupon expired. In the latter case, the agent's portable electronic equipment may also be informed of the exceeding minutes. The returned information may also be an indication that the vehicle is in an irregular condition and its electronic coupon is deactivated, or that the vehicle is in an irregular condition with no electronic coupon.

Apart from this functionality, the system also offers the possibility of the agent to access a Traffic Management Body which is optionally operated by the system. Through providing the license number or plate to a data bank of the Traffic Management Body, the agent can obtain confirmation of characteristics of the vehicle, thus reducing the probability of errors and eventual frauds. This feature will also allow the agent, upon verifying an irregular parking condition, to notify appropriate entities of the violation and penalty, which penalty should be previously determined in the system. Possible parking violation penalties include a warning, an irregularity or violation notification, subject or not to the payment of a tax, or a fine.

All occurrences of parking violations verified during inspection and monitoring the agents should be stored in the system. This enables the generation of recorded registrations containing the identification of the agent and his portable electronic equipment, the license number or plate of the vehicle whose parking status is being verified, the response given by the system, and the consultation code, which can be used in the Module of Writ of fault for future references.

The system can also, by means of the Activating and Deactivating Module, send to the supervising agent, in predetermined time intervals in the system, a list of vehicles parked in his or her monitoring area, and/or the activating periods of which electronic coupons have already expired.

Management of the operational capacity of the operating system for managing parking lots in accordance with the invention will be carried out through a Report Issuing Module connected to the Module of Writ of Failure. The Report Issuing Module makes available management reports which can include the total of issued electronic coupons, the total per point of sale, the total per parking zone, the total of consultations or vehicle checks carried out by the supervision and supervisory agents, the total of warnings, notifications and fines applied, and the tracking of detailed information of an electronic coupon, among others things.

All the parameters related to the set-up of the operating system for managing parking lots in accordance with the invention can be easily altered, such as the value of the tariff charged, the days and times of operation, allocation of the plan of vacancies in differentiated parking zones with individual characteristics, the conditions for commercializing special or promotional electronic coupons, the list of license numbers or plates with definite or temporary exemption, the control of event notification by SMS, such as, for example, warnings about the balance about to be expired, and methods of notifying irregularities or violations among other things.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. An operating system for managing parking lots, comprising:
means for providing information about a vehicle and enabling purchase of electronic coupons to allow the vehicle to park in the parking lot, the provided information includes an identification of the vehicle, an amount of hours sought to be purchased for parking the vehicle, and a telephone number to be used for activating and deactivating use of the electronic coupon;
a reception module arranged to receive the provided information about the vehicle;
an electronic coupon issuing module coupled to said reception module and arranged to generate the electronic coupon based on the provided information and payment, the electronic coupon containing an assigned number, provided information and a password to enable activation and deactivation of the electronic coupon;
means for storing the provided information about the vehicle and payment information in association with each electronic coupon; and
an activation and deactivation module arranged to enable activation and deactivation of each electronic coupon upon entry of the number of the electronic coupon and the password of that electronic coupon, said activation and deactivation module being arranged to provide a confirmation of activation or deactivation of the electronic coupon to the telephone number associated with the electronic coupon.

2. The system of claim 1, wherein said means for providing information comprise a sales terminal.

3. The system of claim 2, wherein said means for providing information comprise data transmitting means for transmitting information from sales terminal to said reception module.

4. The system of claim 1, wherein the means for providing information comprise a computer electronically linked to the means for receiving information and remote from the means for receiving information.

5. The system of claim 4, wherein the computer is linked to said reception module through the Internet or through a fixed or mobile telephony system.

6. The system of claim 1, wherein said means for providing information enable payment for the electronic coupon before and after issuance of the electronic coupon.

7. The system of claim 1, wherein the provided information further includes an identification of an owner of the vehicle.

8. The system of claim 1, further comprising a data correcting module arranged to enable correction of the provided information after information is provided by said means for providing information and prior to issuance of the electronic coupon.

9. The system of claim 1, further comprising a payment confirmation module arranged to confirm payment for the electronic coupon and allow for generating of the electronic coupon by said electronic coupon issuing module only after payment is confirmed.

10. The system of claim 1, wherein said activation and deactivation module is arranged to enable the number and password of each receipt to be sent via a SMS (Short Message System) type message, through a mobile telephone assigned the telephone number of activating and deactivating the electronic coupon or via a call or assistance center.

11. The system of claim 1, further comprising an hour usage control module arranged to send a message to the telephone number associated with each electronic coupon when a parking period is near its end to thereby enable extension of the parking period or provide the user with a warning about the need to move the vehicle.

12. The system of claim 1, further comprising a portable electronic device for use by an agent and communicating with said activation and deactivation module to provide identification information about a vehicle to said activation and deactivation module and receive in response information as to the permissiveness of the parking of the vehicle.

13. The system of claim 12, wherein said portable electronic device is a PDA.

14. The system of claim 12, wherein the information provided by said activation and deactivation module to said portable electronic device is whether the vehicle is exempt from parking regulations, whether the vehicle is permissively parked and if so an amount of time remaining, whether the vehicle is in violation of parking regulations and if so an amount of time of the violation.

15. The system of claim 12, wherein said portable electronic device is arranged to communicate with a traffic management body to provide an identification of the vehicle to the traffic management body and receive information about the vehicle.

16. The system of claim 12, further comprising a violation issuing module coupled to said portable electronic device and arranged to notify said portable electronic device about a parking violation.

17. The system of claim 16, further comprising a report issuing module coupled to said violation issuing module and arranged to compile reports about use of said portable electronic device by the agent.

18. The system of claim 12, wherein said activating and deactivating module is arranged to send to said portable electronic device at predetermined time intervals, a list of vehicles parked in its actuating area and their activating periods of which electronic coupons have already expired.

19. The system of claim 12, further comprising a report issuing module arranged to compile management reports including a total of issued electronic coupons, a total per each of said means for providing information, a total per parking zone, a total of consultations carried out by the agent via said portable electronic device, a total of parking violations determined by said activating and deactivating module based on data from said portable electronic device, and tracking of detailed information of the electronic coupons.

20. The system of claim 1, wherein parameters related to setup of the system are alterable including value of a tariff charged, days and times of operation, allocation of vacancies in parking zones, conditions for commercializing special or promotional electronic coupons, a list of vehicles with exemptions, and control of event notification.
